(19) United States
(12) Patent Application Publication
(10) Pub. No.: US 2008/0284139 A1
(43) Pub. Date: Nov. 20, 2008

(54) Special portable vending machine trailer device

(76) Inventor: John D. Shockley, Muncie, IN (US)

Correspondence Address: RITCHISON LAW OFFICES, PC;John D. Ritchison, Suite A, 115 East Ninth Street, Anderson, IN, 46016-1509, US

(21) Appl. No.: 11/974,978

(22) Filed: Oct. 17, 2007

Related U.S. Application Data
(60) Provisional application No. 60/852,905, filed on Oct. 18, 2006.

(51) Int. Cl. B60P 1/00

(52) U.S. Cl. 280/727; 414/800

(57) ABSTRACT

A device known as a Special Portable Vending Machine Trailer has been developed for use as a more economical, safer and versatile manner to provide vending machines at specific locations and events. The device permits delivery and placement of vending machines in an efficient, safe and secure manner. The preferred embodiment is essentially comprised of a trailer with features to permit easy movement and lowering to the ground/surface; an enclosure with features and configurations to protect and secure the vending machine(s); and a means to secure and connect the vending machines to the trailer device within the enclosure.

### CROSS-REFERENCE TO RELATED APPLICATIONS

This application claims the benefit of Provisional Patent Application Ser. No. 60/852,905 filed Oct. 18, 2007 by John D. Shockley, and titled “Special Portable Vending Machine Trailer Device”.

### FIELD OF INVENTION

This invention relates to a special trailer used to easily transport and set-up vending machines at various locations. Particularly, this device is a high security, low set-up and easy preparation device which may enable one person to easily and safely deliver one or several vending machines to a specified location. The special trailer enables the consumer of the vending machine products easy access for use while maintaining security of the machines, contents and monetary proceeds for the operator/leaser. The trailer may be used at elevated heights or lowered to ground/pavement levels. While this device is a combination of many different existing devices (as well as newly added concepts and devices) the new combination device permits a new use when configured in this unique manner. The new combination and manner of use will be demonstrated below.

### FEDERALLY SPONSORED RESEARCH

None

### SEQUENCE LISTING OR PROGRAM

None

### BACKGROUND

### Field of Invention and Prior Art

The new Special Portable Vending Machine Trailer Device described in this specification is a combination of products and devices that are designed to easily and quickly provide a new and unique way to transport vending machines, enable fast set-up, and present a high degree of security for the vending machines and the contents of the machine.

A. Introduction of the Problems Addressed

The concept of an improved method to provide and serve vending machines gained much momentum when the vending machine companies came under the pressure of fast set-up time for events, increasing labor costs to meet the time constraints, and significant losses to the machine companies due to vandalism and theft. As will be explained in detail below this Special Portable Vending Machine Trailer Device addresses these needs and provides a durable alternative to presenting vending machines in an efficient, safe, and secure manner.

B. Prior Art

Historically, vending units have been transported in many ways such as a truck or trailer but have required significant labor and time to set-up. This delayed use and often required overtime and multiple employees to handle the machines. Likewise, transportation was very specific to the machines to be transported. In use, the prior art devices were often complex, difficult to install, expensive to operate, and limited in use. The new Special Portable Vending Machine Trailer Device addresses these limitations and provides a solution to the stated problems.

Examples of prior art demonstrating mobile vending devices are as recent as U.S. Pat. No. 6,345,852 issued to J. J. McCarthy (2002). This teaches a fixed wheel trailer with wire mesh and external hinges. It features an internal generator and open mesh only to the front of the machines. With the limited ventilation, this device will not be able to support a soda, food, or ice cream vending machine. The Shockley device has expanded metal on the lower section of the back to provide ventilation. The rear wire mesh could be cut by vandals, however it would not provide access to the front of the vending machines were money and product is stored. The Shockley device uses plates at the bottom of the vending machine and will not restrict any air flow. The McCarthy device teaches a wire mesh door for protection of the vending machines. This door could easily be cut open with wire cutters or bolt cutters for access to the front of the vending machines. The Shockley design uses steel vertical bars that can not be easily cut with hand tools. McCarthy has no easy way to dismount the wheels. There is no system or method to remove the wheels such as the jacks offered and taught by Shockley. There is no mention of sprung wheels, which is needed to insure that the vending machines would not get damaged in transportation. The generator in McCarthy is mounted inside the structure limiting ventilation. In the McCarthy description, the brackets for securing the vending machines surround the vending machines to keep them stable. This system will only keep them from moving side to side, not up and down. The up and down movement will happen during transportation and poses possible loss of product out of the machine. Another vending machine device is taught by M. J. Barnhill as issued U.S. Pat. No. 6,295,767 (2001). It teaches a security housing for vending machines that is stationary. This Barnhill device does not include a system to easily transport itself or the vending machines that are contained. Shockley teaches a design that transports itself and the vending machines as one unit on wheels which may be easily removed. The device by Shockley is a transportable device that may easily become stationary at its point of use, if desired. The Barnhill device teaches a roll-up door on the unit. The roll-up door will not give access to the machines for customer use at all times. When the roll-up door is up there is nothing to protect the machines from being damaged. Shockley provides doors will allow access to the machines for the customer at all times and continuously give protection for the machines at all times.

Other examples of vending machine devices continues with a U.S. Pat. No. 5,918,491 issued to D. H. Maxwell (1999) which teaches a method for tamper-proof locking device for vending machines and the like. Maxwell teaches a form of a lock box for inside the vending machine, which would protect the money in the machine. This unit will not protect the product inside the machine, nor the entire machine. This unit will not transport the machine. Shockley teaches a device that will protect all parts of the machine and transport them. A U.S. Pat. No. 5,860,714 issued to C. R. Skord, Jr. (1999) teaches a device that mounts directly into a wall for vending devices. While providing security to an extent, this is not transported easily. Shockley is not for solely an individual vending machine, it is an enclosure for protecting and transporting individual vending machine(s) and the like. There is no need for a building or wall with the Shockley device.

A storage or protection device for an automatic transaction machine is shown in U.S. Pat. No. 5,526,615 issued to T. Kaizu et al. (1996) a secure, stationary enclosure for banking devices. The unit is designed exclusively for an Automatic Transaction Machine (ATM). It appears to be a permanent structure. Shockley will support any type of machine with only having to adjust the bolt down plates and these vending units can be moved to different locations very easily. Another vending machine security device is taught in U.S. Pat. No. 5,108,166 issued to K. Klix (1992) that teaches a method and apparatus for a single vending machine. The Shockley device supports multiple units. The Klix device does not have any form of wheels to transport the vending machine. Shockley is for the transport and protection of one or more vending machines.

A prefabricated, stationary enclosure for different things is shown and taught by the U.S. Pat. No. 3,470,658 issued to F. Orliac (1969). The unit is a prefabricated enclosure. This unit could conceivably surround a vending machine for protection. However, a person would not be able to access the machine unless the door is open which would make the vending machine vulnerable. This Orliac unit is not a whole portable unit that would also transport a vending machine. The Shockley concept allows continuous access and transport a vending machine.

As far as known, there are no vending trailers or transport means at the present time which fully meet this need with as few of components and superior operation as the present Special Portable Vending Machine Trailer Device. It is believed that this device is made with fewer parts, of a more durable design, and with much less expense than any previous vending machine or food related transport device. To the best knowledge of the inventor, this combination and use has not been anticipated by other products, patents or combinations of patents in view of each other.

### SUMMARY OF THE INVENTION

A Special Portable Vending Machine Trailer Device has been developed for use to answer and present a more economical, safer and versatile manner to provide vending machines at specific locations and events. The new Special Portable Vending Machine Trailer Device permits the user to deliver and place vending machines in an efficient, safe and secure manner. Specifically, the preferred embodiment of the Special Portable Vending Machine Trailer Device is essentially comprised of a trailer with features to permit easy movement and lowering to the ground/surface; an enclosure with features and configurations to protect and secure the vending machine(s); and a means to secure and connect the vending machines to the trailer device within the enclosure. The materials and configurations may be of several manners and still be well within the spirit and scope of this unique system.

The newly invented Special Portable Vending Machine Trailer Device features very few parts and may be built easily and quickly at a metal fabrication facility. In operation, the new Special Portable Vending Machine Trailer Device may be easily transported to whatever location it is needed and quickly attached to existing utilities or use self-contained utilities described below.

### OBJECTS AND ADVANTAGES

There are several objects and advantages of the Special Portable Vending Machine Trailer Device. One advantage and object of the present invention is that it is safe and ergonomically friendly. The trailer features permit the whole device to be lowered to the ground/surface level. Rather than moving and lifting machines into a location and spending time to load and unload individual machines, the trailer device permits one person to deliver and provide the vending machine(s). On the trailer, the vending machines are safely and securely connected to the trailer frame and deck. The enclosure has a ventilation screen to permit airflow and cool operation of the vending machines that have heating or cooling mechanisms. Heavy duty jacks permit the entire Special Portable Vending Machine Trailer Device to be lowered to surface level for easy access, especially for disabled individuals. On the trailer, the special wheel and spring mechanisms and features provide a low center of gravity for transport of the device to greatly reduce chances of tipping the machines or loaded trailer.

Another advantage is that the Special Portable Vending Machine Trailer Device is versatile for use. The whole structure is configured to permit placement in tight locations and lower the machines to the ground level. Wheel systems may be placed on the sides or ends of the trailer for improved maneuverability. The entire jack and wheel systems can be removed and permit the “enclosure” to be streamlined without additional features near the enclosure. The ability to deliver the trailer quickly is an improvement to existing manners of providing separate machines, unloading, setting in place and then filling the contents. The cage/bar doors described below allow full access to the contents of the machine. If desired, the front doors may be removed. This may be desired for interior events where security is not a concern. Utilities may be connected directly from the location utility systems or provided by generators and the like carried on the trailer for remote use.

A further advantage is that it is more labor efficient to use the Special Portable Vending Machine Trailer Device. The vending machines may be scheduled and filled away from the event. This permits the machines to be prepared in a more steady flow and not in a rush at heavy use periods such as weekends. After earlier preparation, the trailer(s) is/are then delivered “ready for use” by one person. If many machines are desired, additional trailers may be provided to the location in a shorter delivery and set-up time for the event directors. Once completed for the specified location, the trailer and machines are returned and recycled for the next event/use.

Another advantage is that it is more secure than individual machines. The Special Portable Vending Machine Trailer Device provides a system that is lockable and the enclosure protects the machine, contents and proceeds. Therefore, the money and contents are secure from theft and the machines are safe from vandalism.

Finally, other advantages and additional features of the present Special Portable Vending Machine Trailer Device will be more apparent from the accompanying drawings and from the full description of the device. For one skilled in the art of building and providing trailers and vending machines, it is readily understood that the features shown in the examples with this mechanism are readily adapted to other types of trailer and vending machine devices and systems.

### DESCRIPTION OF THE DRAWINGS

### Figures

The accompanying drawings, which are incorporated in and constitute a part of this specification, illustrate an embodiment of the Special Portable Vending Machine Trailer Device that is preferred. The drawings together with the summary description given above and a detailed description given below serve to explain the principles of the Special Portable Vending Machine Trailer Device. It is understood, however, that the Special Portable Vending Machine Trailer Device is not limited to only the precise arrangements and instrumentalities shown.

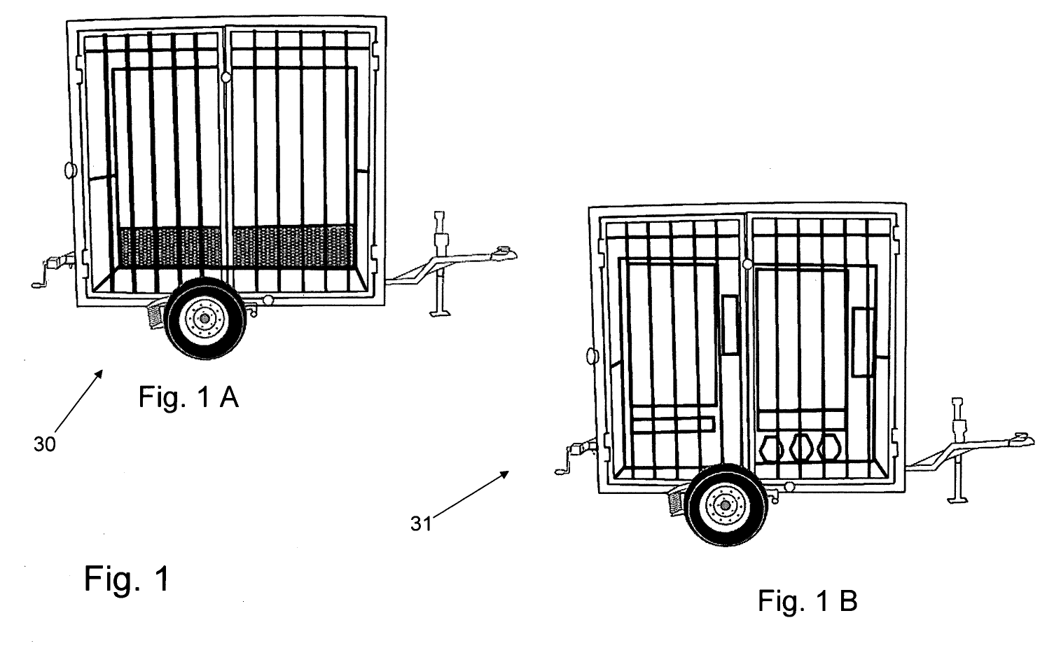

FIG. 1A is a sketch of Special Portable Vending Machine Trailer Device.

FIG. 1B is a sketch of Special Portable Vending Machine Trailer Device with vending machines.

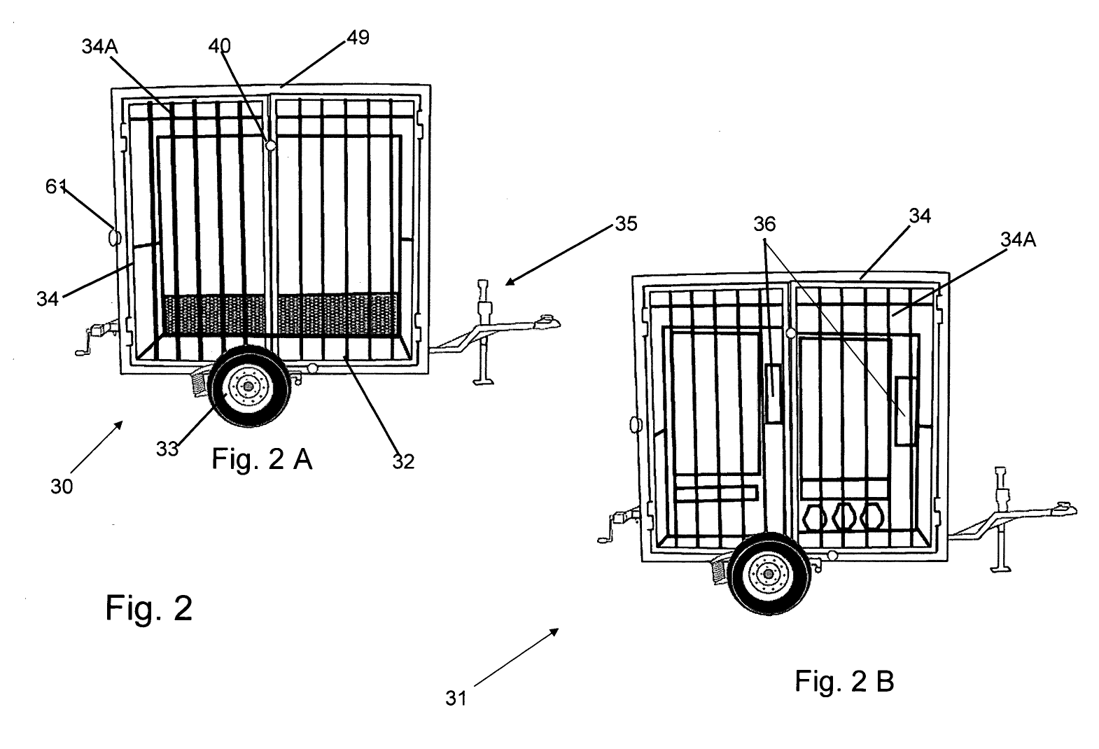

FIG. 2 A is a sketch of Special Portable Vending Machine Trailer Device with component details. FIG. 2 B is a sketch of Special Portable Vending Machine Trailer Device with vending machines with component details.

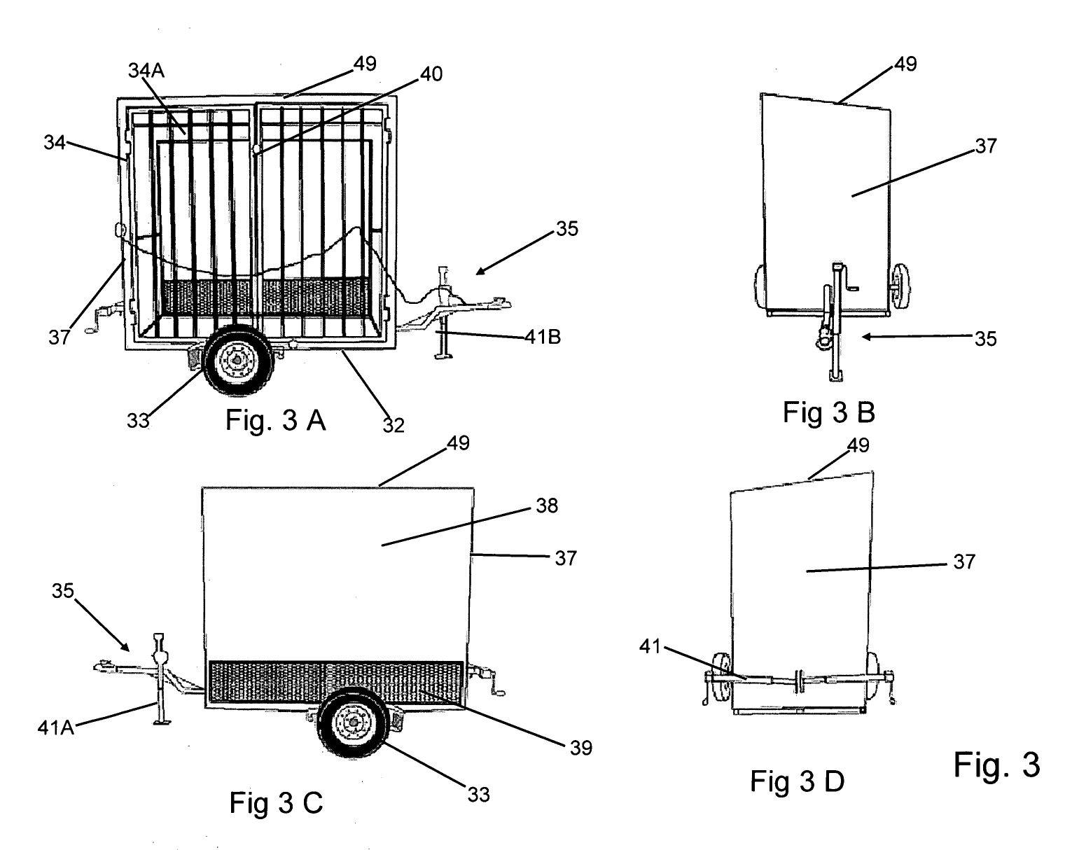

FIG. 3 A through 3 D are sketches of the four (4) sides of a prototype of the Special Portable Vending Machine Trailer Device.

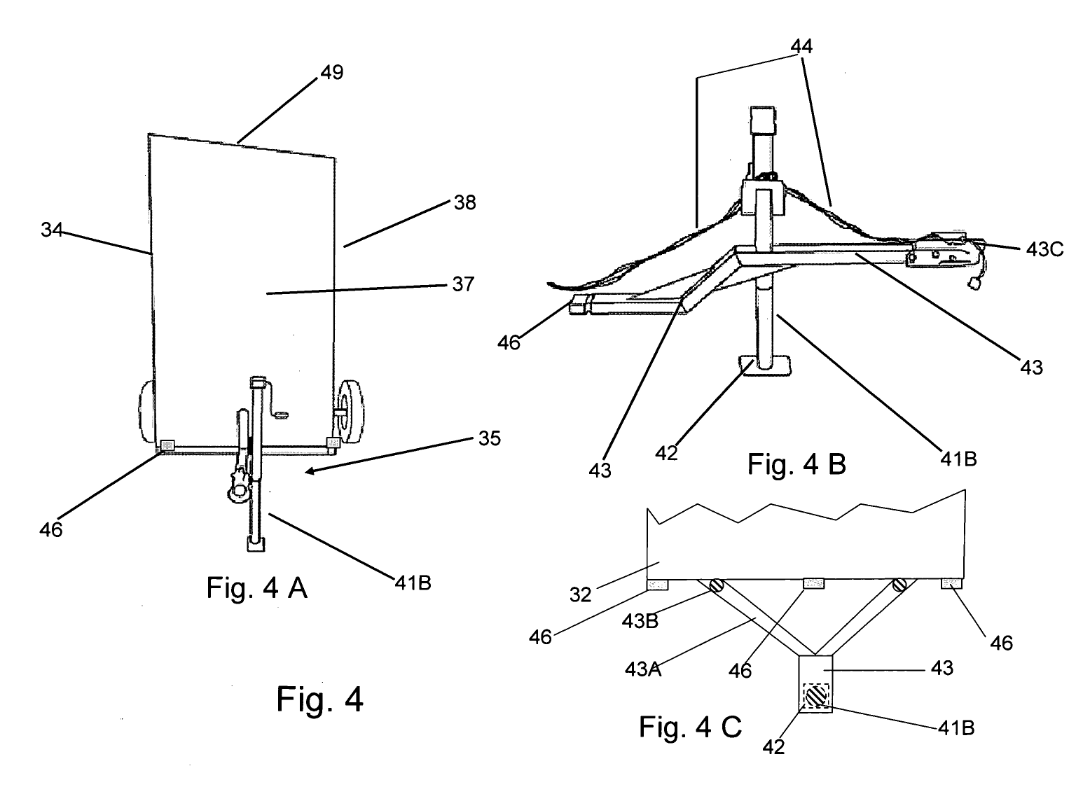

FIGS. 4 A through 4 C are sketches of the preferred and alternative hitch device for the trailer.

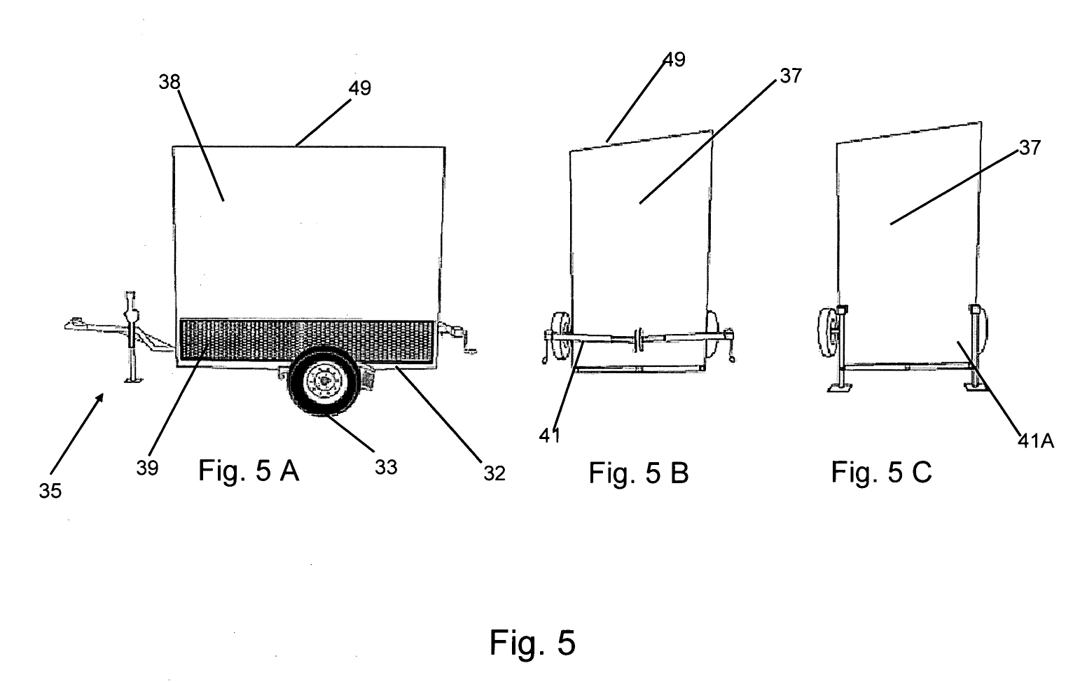

FIGS. 5 A through C are sketches of the hitch and jacks for the trailer device.

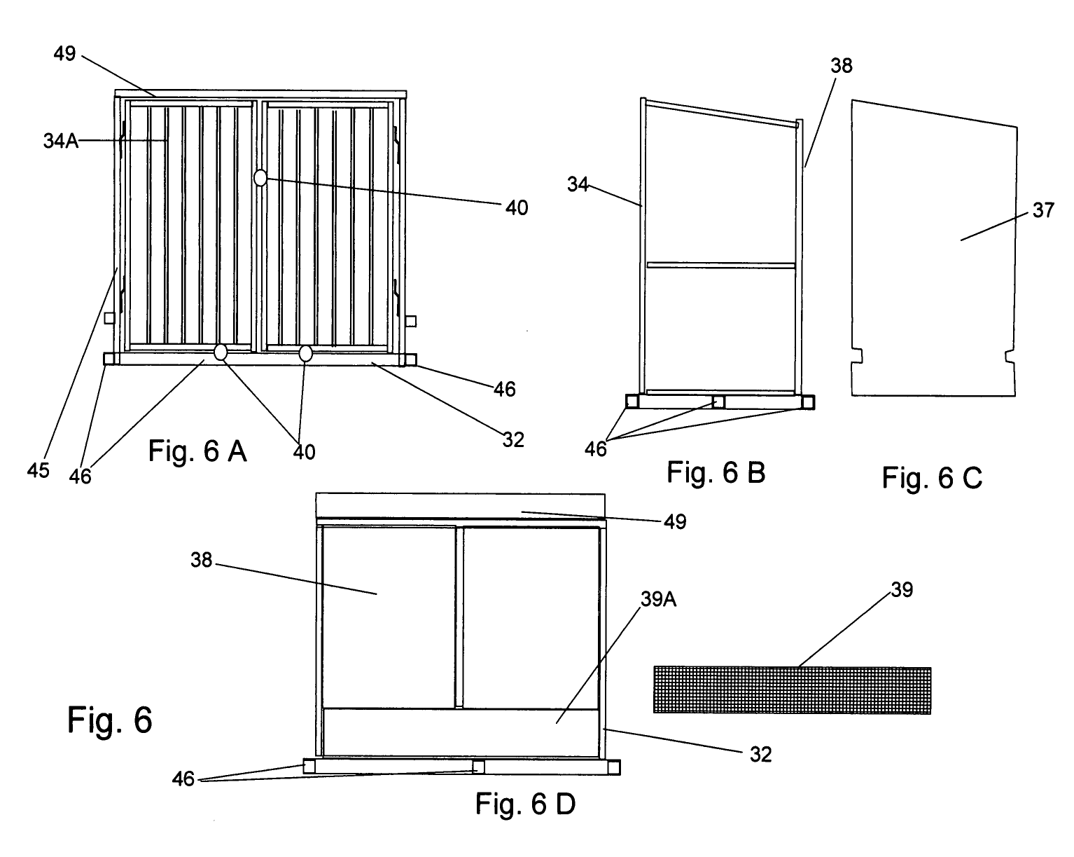

FIGS. 6 A through D are sketches for the original prototype trailer.

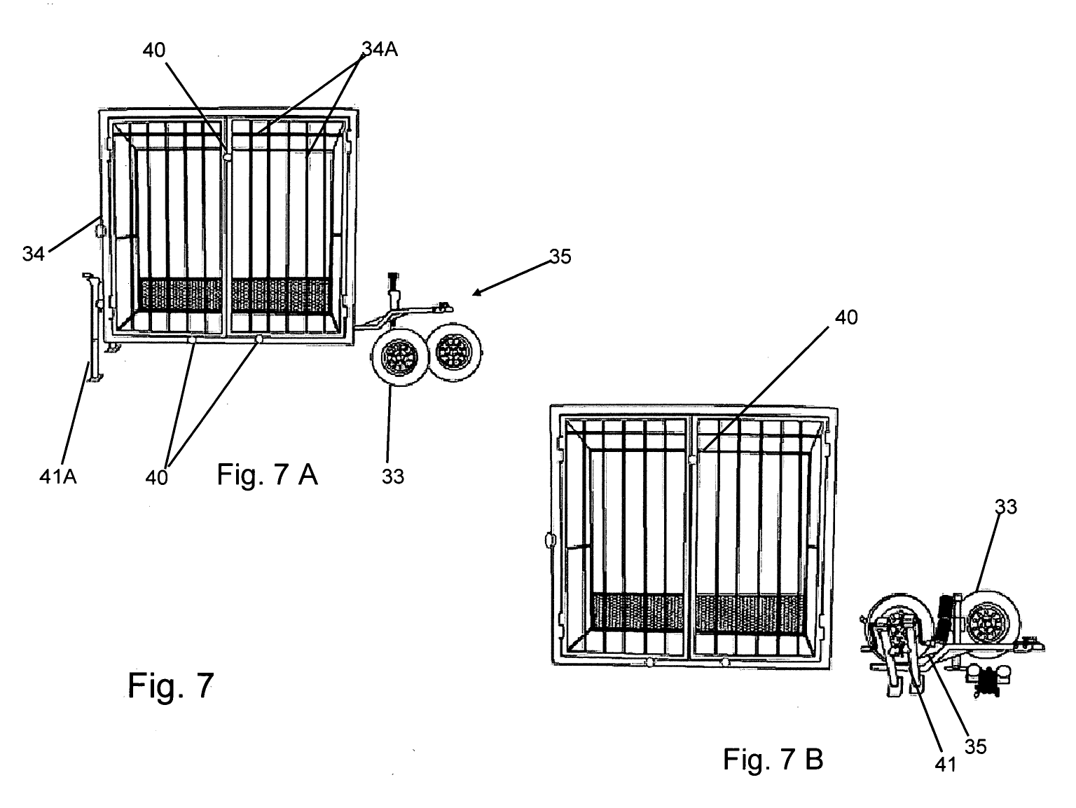

FIGS. 7A and B are sketches of the elevated and lowered trailer device.

FIG. 8 are original sketches of the side view of the trailer.

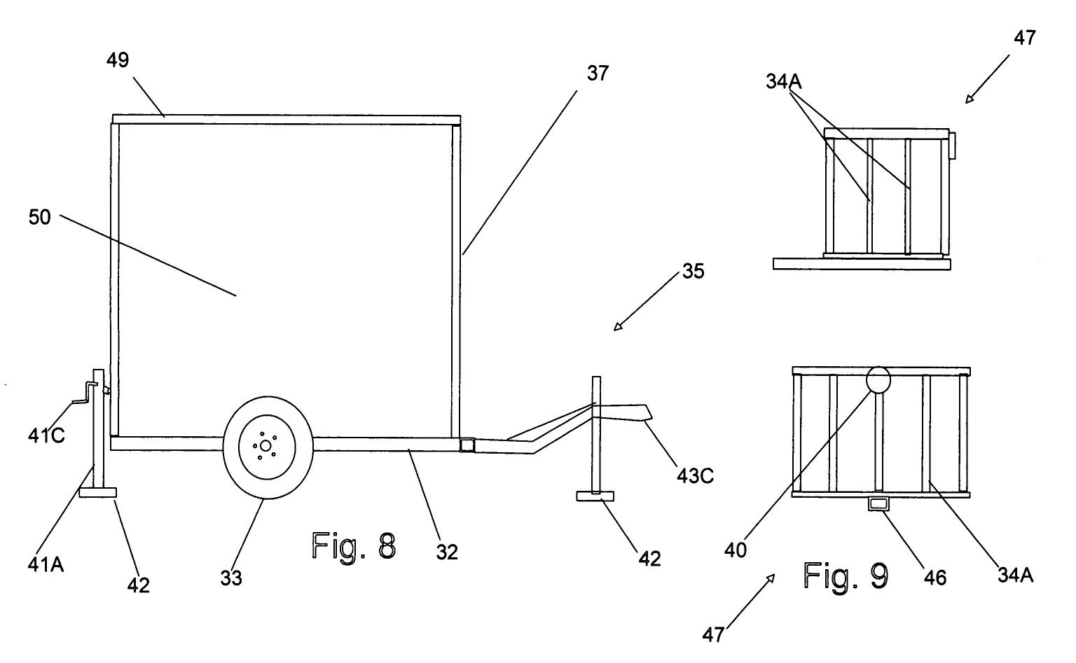

FIG. 9 is a sketch of a special cage for a generator of special auxiliary equipment.

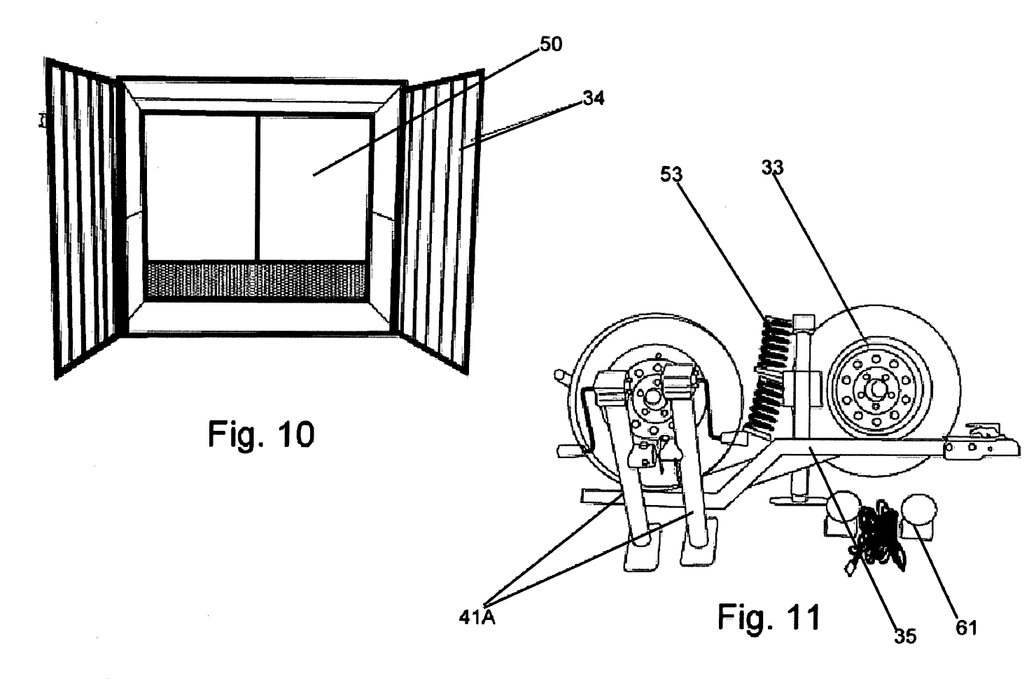

FIG. 10 is a sketch of a vending enclosure opened fully for access.

FIG. 11 is a sketch of jacks, wheels and supports disconnected from main trailer body.

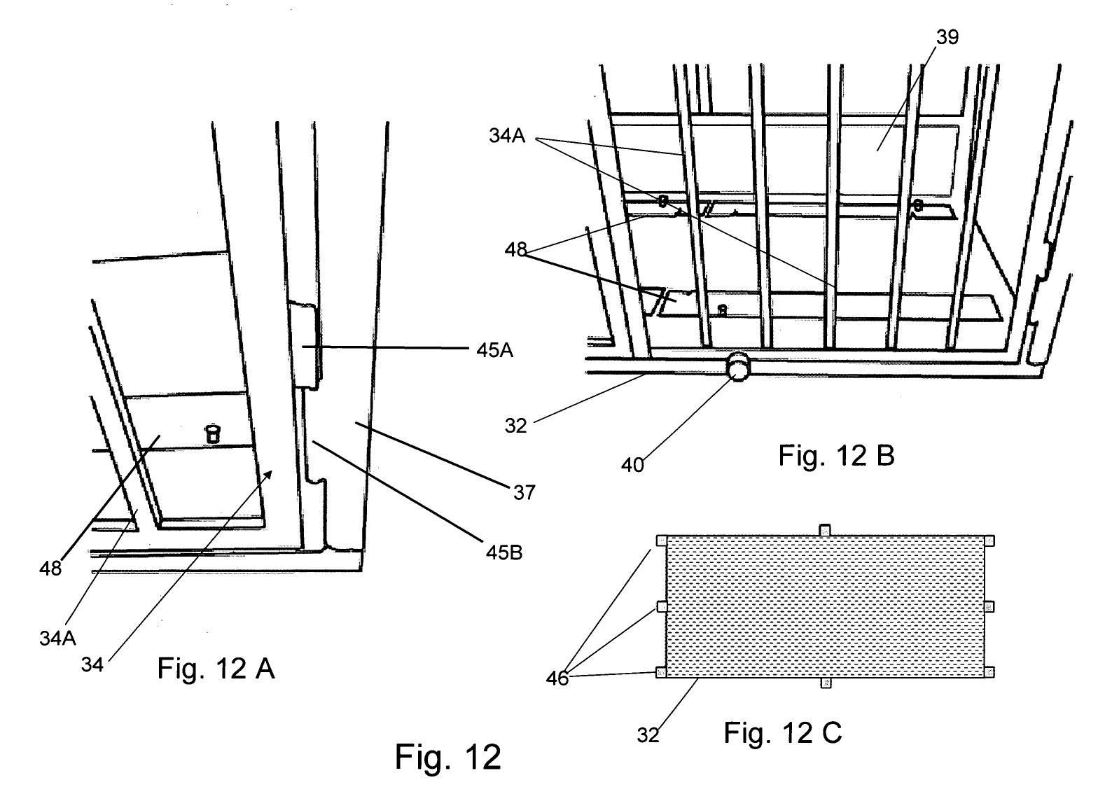

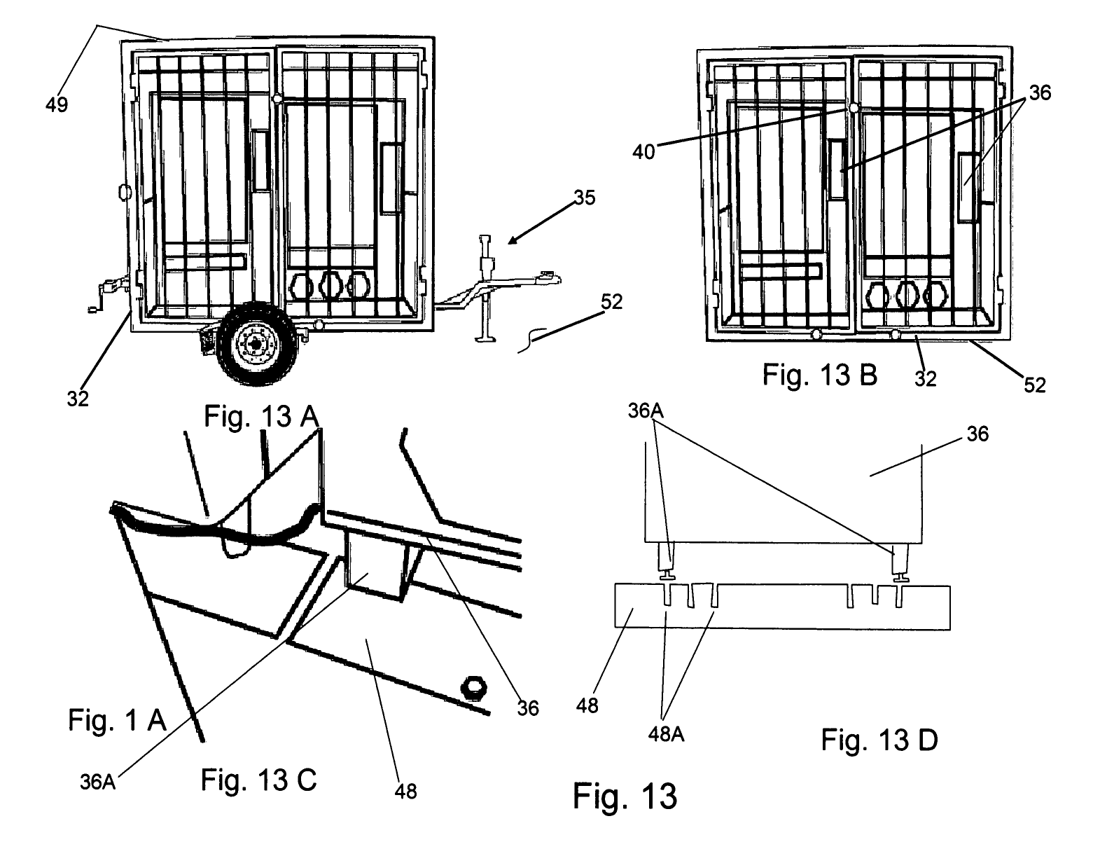

FIG. 12A is a sketch of a door hinge details. FIG. 12B is a sketch of a door and frame lock assembly. FIG. 12C is a sketch of a trailer frame and examples of locations for the tube receivers.

FIGS. 13 A and 13 B are sketches of a trailer on wheels and lowered to support surface. FIGS. 13 C and 13 D are sketches of means to provide a secure connection of the Vending machine to the trailer base.

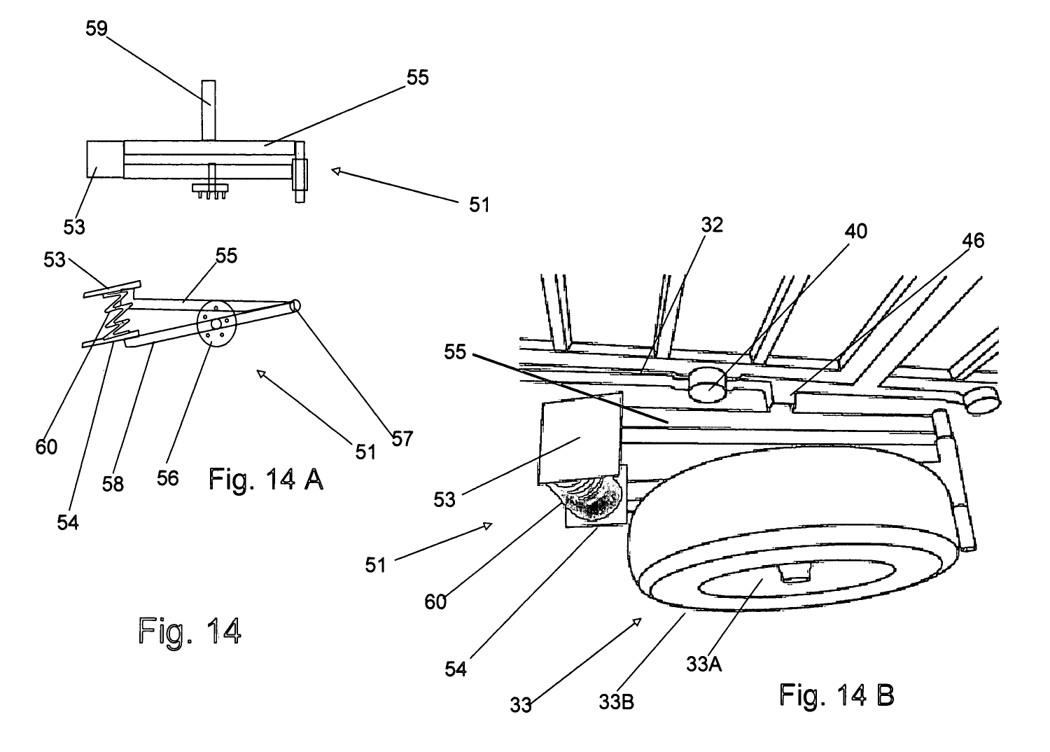

FIGS. 14 A and 14 B are sketches of the wheel assembly and connection to the trailer frame.

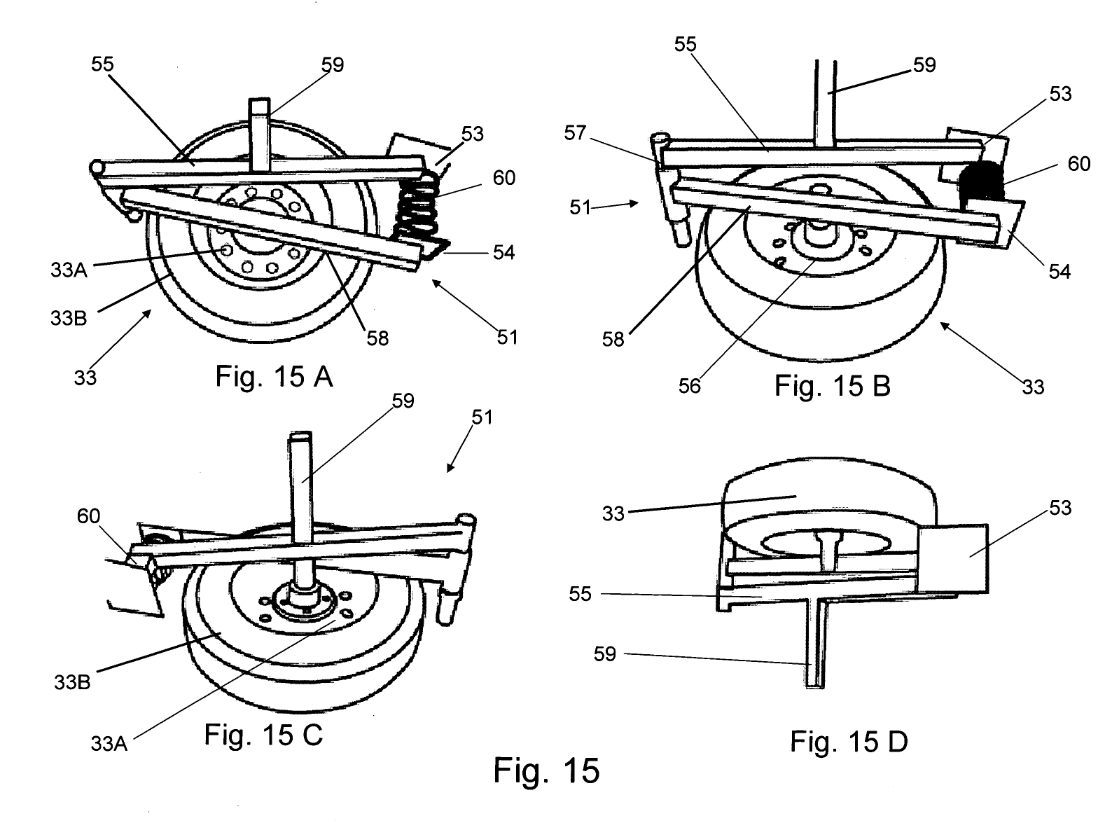

FIGS. 15 A through 15 D are sketches of details to connect wheel assemblies to the trailer frame.

### DESCRIPTION OF THE DRAWINGS

### Reference Numerals

The following list refers to the drawings:

| Item | Description |
|---|---|
| 30 | General sketch of Special Portable Vending Machine Trailer |
| | Device |
| 31 | General sketch of Special Portable Vending Machine Trailer |
| | Device with vending machines |
| 32 | Frame of trailer device |
| 33 | Wheels |
| 33A | Rim |
| 33B | Tire |
| 34 | Cage door |
| 34A | Bars of cage |
| 35 | Main hitch |
| 36 | Vending machine(s) |
| 36A | Vending machine base support (leg, strut, member, or the like) |
| 37 | Side panels |
| 38 | Back panel |
| 39 | Ventilation screen |
| 39A | Space for Vent Screen |
| 40 | Locking means |
| 41 | jacks |
| 41A | Vertical jacks |
| 41B | Movable telescoping tube of jack |
| 41C | Jack actuator/handle |
| 42 | Base plate for jack |
| 43 | Hitch tongue structure |
| 43A | Alternative sway bars for hitch |
| 43B | Means to connect to frame |
| 43C | Ball receiver for hitch |
| 44 | Electrical connection means |
| 45 | Removable door hinges |
| 45A | Male hinge half |
| 45B | Female hinge half |
| 46 | Tube receiver structure (with aperture for retaining pin means) |
| 47 | Generator or special equipment cage |
| 48 | Vending machine base plate |
| 48A | Slot and means to secure vending machine leg strut (36A) |
| 49 | Top of enclosure |
| 50 | Open interior to enclosure |
| 51 | Mounting spring system |
| 52 | Ground or support surface |
| 53 | Upper spring plate |
| 54 | Lower spring plate |
| 55 | Fixed strut |
| 56 | Wheel hub |
| 57 | Strut pivot connection |
| 58 | Rotating strut |
| 59 | Mounting member |
| 60 | Mounting spring(s) |
| 61 | Electrical lights and reflectors |

### DETAILED DESCRIPTION OF PREFERRED EMBODIMENT

The present device is a Special Portable Vending Machine Trailer Device that has been developed for use to answer and present a more economical, safer and versatile manner to provide vending machines at specific locations and events. Specifically, the preferred embodiment of the Special Portable Vending Machine Trailer Device 30 is essentially comprised of a trailer with features to permit easy movement and lowering to the ground/surface; an enclosure with features and configurations to protect and secure the vending machine(s); and a means to secure and connect the vending machines to the trailer device within the enclosure. The materials are easily processed and manufactured to provide many other optional features within the normal course of constructing a trailer and enclosure device. A person having ordinary skill in the field of utility trailers and vending machines appreciate the configuration and improvement accomplished by using the Special Portable Vending Machine Trailer Device. They also understand the general construction and appreciate the various manners that may be used to physically permit this Special Portable Vending Machine Trailer Device 30, to be produced and utilized.

The improvement over the existing art is providing a device that:

a. is safe and ergonomic;

b. is versatile for many uses;

c. is economical compared to existing practices; and

d. is more secure than current practices.

There is shown in FIGS. 1-15 a complete operative embodiment of the Special Portable Vending Machine Trailer Device 30. In the drawings and illustrations, one notes well that the FIGS. 1-15 demonstrate the general configuration and use of this invention. The preferred embodiment of the device is comprised of only a few parts as shown in the drawings. These structural members or parts are essentially comprised of and include, but are not limited to, a trailer with features to permit easy movement and lowering to the ground/surface; an enclosure with features and configurations to protect and secure the vending machine(s); and a means to secure and connect the vending machines to the trailer device within the enclosure. Most of the materials used are readily available and are easily processed to provide many other optional features within the normal course of constructing a trailer and enclosure device. Various important features of these member components are delineated in FIGS. 1-15 of the drawings and are described below in appropriate detail for one skilled in the art to appreciate their importance and functionality to the Special Portable Vending Machine Trailer Device 30.

The accompanying drawings, which are incorporated in and constitute a part of this specification, illustrate an embodiment of the Special Portable Vending Machine Trailer Device 30 that is preferred. The drawings together with the summary description given above and a detailed description given below serve to explain the principles of the Special Portable Vending Machine Trailer Device 30. It is understood, however, that the Special Portable Vending Machine Trailer Device 30 is not limited to only the precise arrangements and instrumentalities shown.

FIG. 1A is a sketch of Special Portable Vending Machine Trailer Device 30. This is the preferred embodiment of the present concept for the improved vending trailer. FIG. 1 B is a sketch of Special Portable Vending Machine Trailer Device with vending machines 31. This demonstrates the general combination of an enclosed trailer device used in a new manner to transport and house vending machines. The configuration and features are shown below.

FIG. 2 A is a sketch of Special Portable Vending Machine Trailer Device 30 with some component details. Here the various components and features are depicted. The main frame and case floor 32 is supported by the wheel assembly 33. Above and connected to the base frame and floor 32 is the front cage doors 34. Additionally, these doors 34 feature a plurality of lock mechanisms 40 that keep the enclosure secure from theft and vandalism or the like. The enclosure is covered by a sloped roof 49. The ends 37 and back 38 (not shown but described below) complete the trailer enclosure with an area for the vending machines 36. The entire Special Portable Vending Machine Trailer Device 30 includes a hitch mechanism 35 to enable the device to be transported by a vehicle with a ball and trailer hitch system. FIG. 2 B is a sketch of Special Portable Vending Machine Trailer Device 31 with vending machines 36 with component details. The details are similar to those just described. The specific vending machines 36 are also shown in this general view. Materials and dimensions are described below.

FIG. 3 A through 3 D are sketches of the four (4) sides of a prototype of the Special Portable Vending Machine Trailer Device 30. FIG. 3 A shows the front view of the Special Portable Vending Machine Trailer Device 30. Depicted are the wheel assembly 33, the hitch 35 and the general enclosure. The enclosure is comprised of the front cage door 34 which is of two leafs that are hinged on the ends 37. The general door 34 is also comprised of tubular structures 34A such as square, round or ovular tubing. The doors 34 are secured by the locks 40 at the top and along the bottom frame and floor 32. The cover to the enclosure is the top roof 49. FIG. 3 B shows the front end of the trailer where the towing hitch 35 is depicted. The end panel 37 and the hitch 35 are shown. The roof 49 is shown as sloped to enable moisture to not “stand and pool” on the top horizontal surface. FIG. 3 C shows the rear side 38 opposite of the entry/access doors 34. Here the panel 38 also has a ventilation section 39 to permit cool running for the vending machines 36. FIG. 3 D shows the end opposite of the enclosure to the tongue end. One note here the presence of two support jacks 41 connected and swiveled to a neutral, non-support position.

In all the views of the Special Portable Vending Machine Trailer Device 30, one skilled in the art of trailers and enclosures understands and appreciates the plethora of materials and fastening means that may be combined to achieve the trailer and enclosure. The frame and floor 32 may be of structural members to form the frame such as, for example and not for limitation, “C” channels, I or W beams, “T” beams and rectangular, square or round tubes. The material may be any metal, such as steel and other various steel alloys and metals; composite materials; and plastics. The floor of the frame and floor 32, the end panels 37 and the back 38 may be of solid or perforated sheet metal, expanded metals, or composite or plastic sheet. Similarly, solid sheet metal, expanded metals, or composite or plastic sheet may be used for the ends, backs and top or roof (although the roof is best a solid, weather repellant configuration for most operations). The ventilation panel 39 may be of similar materials in a perforated or expanded metal or composite type system. All of these materials may be pre-colored from the factory or, for example, either surface prepared with a powder coating or painting after assembly. The connection and fastening means will be determined, largely, from the materials needed to be joined. Fasteners such as bolts and self-tapping screws are useful; adhesives; fusion bonds; welding and brazing. Other joining techniques may be appropriate and still be within the scope and spirit of this invention. Most of the jacks 41, trailer ball receivers 43C and lock mechanisms 40 may be purchased from vendors and are well known and appropriate in the trailer industry and appropriate for this invention of the Special Portable Vending Machine Trailer Device 30.

FIGS. 4 A through 4 C are sketches of the preferred and alternative hitch devices for the trailer. The hitches 35 are connected to the frame 32 by means of the tube receiver 46. In FIG. 4 A, the front view depicts the receivers 46 in the frame 32 as well as the telescoping or extended tube 41B. FIG. 4 B is a close-up of the hitch 35 that shows the extension tube 41B placed and connected to the jack base plate 42. The electrical wires 44 run from the connector (for the vehicle) to the trailer lighting and electrically powdered mechanisms (not shown). The ball receiver 43C is demonstrated in the sketch. It is integrally connected to the hitch “tongue structure” 43. In FIG. 4 C, an alternative tongue configuration includes sway bars 43A connected by a means 43B to the trailer frame 32. The need for the sway bars require some additional empirical or analytical testing. This configuration is significantly stronger and more stable than a single tube hitch 43. All the embodiments anticipate a base plate 42 and a means 43B or other method to connect the single tongue 43 or combined tongue with sway bars 43A to the frame 32. This may be a fastener or some other connection means such as welding.

FIGS. 5 A through C are sketches of the hitch 35 and jacks 41 for the trailer device 30. The roof 49, the end panels 37 and the back panel 38 with the screen 39 have been previously described, above. FIG. 5 B shows the jacks 41 in the horizontal or inactive position and FIG. 5 C shows the jacks 41A in the extended position.

FIGS. 6 A through D are sketches for the original prototype trailer. FIG. 6 A shows the front or door side with the doors 34 and securing locks 40 as described earlier. The mechanism that permit the doors to be removed are the sliding hinges 45 described below. FIGS. 6 B and 6 C show the end panels and possible interior separation/divider panels. FIG. 6 D demonstrates the back panel 38 with the ventilation screen 39.

FIGS. 7A and B are sketches of the elevated (FIG. 7 A) and lowered (FIG. 7 B) trailer device 30. In both cases, the wheel assemblies 33, jacks 41 and tow arm 35 have all been removed from their respective receivers 46. One notes that the three locations of the lock mechanisms 40 and the slip-fit hinges 45 (as described in FIG. 12 below) permits the cage door 34 to be fully removed, if desired.

FIG. 8 are original sketches of the side view of the trailer. The end panels 37, open area 50, jacks 41A, wheels 33 and frame and floor 32 are all depicted. The hitch assembly 35 shows the components ball receiver 43C, jack 41A, and base plate 42 as described above.

FIG. 9 is a sketch of a special cage 47 for a generator or special auxiliary equipment. The cage 47 has bars 34A similar to the large cage door 34 and a lock mechanism 40. The section is mounted to the Special Portable Vending Machine Trailer Device 30 by means of an open receiver hitch 46.

FIG. 10 is a sketches of a Special Portable Vending Machine Trailer Device 30 with the vending enclosure 34 opened fully for access. The un-occupied area 50 is shown.

FIG. 11 is a sketch of jacks, wheels and supports disconnected from main trailer body. These features—the wheels 33, the towing hitch 35, the jacks 41A, mounting spring system 51 and the removable lights 61—are removable to allow the trailer 30 and vending machines 36 to be lowered first, then the features removed. Once removed, the chance of theft of the trailer 30 is substantially reduced. Likewise, the access to the vending machines is easier, especially for disabled persons in mobility assist devices and carts.

FIG. 12A is a sketch of a door hinge details. The hinge halves are a male 45A connected to the front cage door 34 and a female 45 B connected to the side 37. The male 45A and female 45B configuration are fixably connected (by welding, adhesives, fasteners, or the like) respectively to the front cage door 34 and the side 37. The cage door 34 is comprised of the cage bars 34A which have been described as tubes, bars or the like made of metal, plastic, composites, or similar rigid members commonly used to make structural members. FIG. 12B is a sketch of a door 34 and frame lock assembly 40. No easy removal of the hinges 45 are possible if the connection is rigid unless the locks 40 are disengaged and removed first. Rigid connections may be for example welding or fasteners that are configured for removal from inside the enclosure. Also shown in this view are the ventilation panel 39 and the vending machine retainer plate 48 (described below). FIG. 12C is a sketch of a trailer frame and floor 32 and examples of locations for the tube receivers 46. One skilled in the art of trailers and tube receivers appreciates the various locations that may support the concept of the Special Portable Vending Machine Trailer Device 30. The versatility of placing the wheels 33 and jacks 41A especially aids the enablement to maneuver the trailer 30 into tight locations and against walls where little space to turn is present.

FIGS. 13 A and 13 B are sketches of a trailer 30 on wheels 33 and lowered to a support surface 52. The other components shown have been discussed and described in the above specification. FIGS. 13 C and 13 D are sketches of means to provide a secure connection of the Vending machine 36 to the trailer floor and frame 32. In FIG. 13 C, the vending machine support strut 36A (member, feet or the like) rests on top of the floor and frame 32 of the Special Portable Vending Machine Trailer Device 30. The vending machine base plate 48 rests on top of and contiguous to the floor 32 and surrounds the vending foot 36A. When in place, this configuration by the plate 48 entraps or holds the foot 36A securely in place by means of a slot 48A integral to the plate 48. The plate 48 in turn is securely fastened by a removable fastening means such as threaded bolts, pins, and the like. The sketch in FIG. 13 D further shows and demonstrates the relationship of the vending plate 48, the slots 48A and the vending machine feet 36A.

FIGS. 14 A and 14 B are sketches of the wheel assembly 33 and connection to the trailer frame 32. FIG. 14 A shows a side sketch and a top sketch of the general mounting system 51 which is preferred. The system 51 is comprised of a fixed strut 55 that is rigidly attached essentially perpendicularly to a lateral mounting member 59. In the sketch in FIG. 14 B, this lateral member 59 is then removably attached into the trailer frame 32 means of a receiver 46.

Further, the fixed strut 55 is pivotally attached to a second movable strut 58 by a rotatable fastening means 57 at one end of the struts 55 and 58. At the opposite end of the fixed strut 55, the said strut 55 is fixed to an upper spring mounting plate 53. On the movable strut 58, at the end opposite from the pivotal connection to the fixed strut 55, there is rigidly attached a lower spring mounting plate 54. Between the two mounting plates 53 and 54, the spring 60 is fixed to one plate 53 at the upper end of the spring 60 and to the lower plate 54 at the lower end of the spring by a fastening means such as a heavy clip and bolt or other rigid means. The wheel assembly 33 is connected to the mounting system 51 by means of a hub 56 (shown in FIG. 15 A through 15 C) that is rigidly affixed to the lower, movable strut 58 (shown in FIG. 15 A through 15 C). The entire structure assembly system anticipates metal tubing and other rigid structural materials and fastening means such as used on other trailer wheel systems and in automotive related applications. This unique configuration permits the whole assembly 51 to keep a low center of gravity for the Special Portable Vending Machine Trailer Device 30 when compared to other trailers and prevents the likelihood of tipping the vending machines 36 due to high loads with respect to the wheels. Additionally, the whole wheel assembly is removable from the receiver 46 if desired. The wheel assembly 33 is comprised of a typical system found on trailers. The tire 33B is mounted directly to the rim 33A. The rim 33A is in turn mounted to the hub 56. Finally, while the described system 51 and wheel assembly 33 is preferred, other removable wheel and mounting systems may be used within the scope of the Special Portable Vending Machine Trailer Device 30.

FIGS. 15 A through 15 D are sketches of details to connect wheel assemblies 33 to the trailer frame 32 by means of the spring mounting system 51. The actual components have been just described, above in FIG. 14. These additional sketches permit additional insight into the scope and uniqueness of this wheel mounting 33 and spring assembly 51 for the Special Portable Vending Machine Trailer Device 30.

All of the details mentioned here are exemplary and not limiting. Other specific components specific to describing a Special Portable Vending Machine Trailer Device 30 may be added as a person having ordinary skill in the field of building trailer and enclosure devices for vending machines.

### Operation of the Preferred Embodiment

The new Special Portable Vending Machine Trailer Device 30 has been described in the above embodiment. Once initially built, the Special Portable Vending Machine Trailer Device 30 is ready to be loaded with vending machines 36 and then transported to an area of need, connected to utilities, and is ready for immediate use to provide vended items. The manner of how the device is used, once built, is shown below. One notes well that the description above and the operation described here must be taken together to fully illustrate the concept of the Special Portable Vending Machine Trailer Device 30. The results will meet the objectives and afford the advantages shown in the above description.

The manner of use will be varied by the specific operations. Various types of food, drinks, and other vended items are anticipated. The Special Portable Vending Machine Trailer Device 30 may hold only one machine 36 or a plurality of types of vending machines 36. The general flow of operation will also vary from one vending company to another. As an example and not as a limitation, the following table describes an example of use:

TABLE A
EXAMPLE OF AN OPERATION

| STEP | DESCRIPTION |
|---|---|
| 1 | Pull trailer from inventory |
| 2 | Pick needed vending machines and secure to trailer |
| 3 | Pre-load merchandise in trailers |
| 4 | Check operation of trailer |
| 5 | Preload change and monies into machines |
| 6 | Transport to user location |
| 7 | Place trailer at proper location |
| 8 | Remove wheels and lower (if desired) |
| 9 | Connect utilities (provided at location or on trailer) |
| 10 | Confirm machines operation |
| 11 | Confirm cage locked and secure |
| 12 | Service periodically as needed |
| 13 | Re-install wheels |
| 14 | Transport to Vending company warehouse |
| 15 | Service and clean machines |
| 16 | Return to inventory special machines or leave on trailer |
| | as desired |
| 17 | Repeat Operation |

The Special Portable Vending Machine Trailer Device may be directly linked to existing utilities or use self contained utilities such as the generator in the cage described above. Equally anticipated, in addition to electricity, are the necessity for some trailers to have water and waste systems, bottled gas, and other utilities. Lights for after-dark use and possible environmental controls (HVAC) may be required. These changes would impact the front cage design. However the feature and ability to pre-load the machines, deliver them easily to the site, remove the wheels are still useful and within the scope of this invention.

With this description it is to be understood that the Special Portable Vending Machine Trailer Device 30 is not to be limited to only the disclosed embodiment. The features of the Special Portable Vending Machine Trailer Device 30 are intended to cover various modifications and equivalent arrangements included within the spirit and scope of the description.

What is claimed as new and desired to be protected by Letters Patent is:

1. A transport and security device for one or more vending machines, comprising:
(a) a trailer with features to permit easy movement and lowering to the ground surface;
(b) an enclosure with features and configurations to protect and secure the vending machine(s); and
(c) a means to secure and connect the vending machines to the trailer device within the enclosure whereby the vending machines may be timely and easily placed at a point of use with minimal human effort.

2. The object according to claim 1 wherein the trailer is comprised of a frame means and a wheel system.

3. The object according to claim 2 wherein the frame means is comprised of rigid structures of a high strength material.

4. The object according to claim 3 wherein the rigid structures are a selected from a structural group consisting of round tubes, oval tubes, rectangular tubes, square tubes, “C” channels, “I” beams, angles, and “T” beams.

5. The object according to claim 3 wherein the high strength material is an alloy of steel suitable for framing trailers.

6. The object according to claim 3 wherein the high strength material is a high strength composite material suitable for framing trailers.

7. The object according to claim 2 wherein the wheel system is spring-mounted.

8. The object according to claim 2 wherein the wheel system is removable.

9. The object according to claim 1 wherein the enclosure encircles the one or more vending machines and is comprised of a roof, a floor side panels, and a door system with a means to secure and a means to lock the door system
Whereby the vending machines are protected while customers may still use the machine and receive merchandise.

10. The object according to claim 9 wherein the means to secure is a plurality of vertical bars in the door system.

11. The object according to claim 9 wherein the means to lock is one or more locking means for securing the door to itself and the trailer frame.

12. The object according to claim 1 wherein a feature of the enclosure is one or more ventilation mesh means in the panels
Whereby fresh, cooler air may be present for the vending machines.

13. The object according to claim 1 wherein the means to secure the machines to the trailer is a universal plate secured to the trailer by a means to secure and the plate having slots and angle tabs to removably secure the vending machines in place by a fastening means.

14. The object according to claim 13 wherein the fastening means is threaded bolts and nuts which may be used with the slots of the plate to secure the machines to the plate and thus to the trailer.

15. A method for providing a group of one or more vending machines in a portable and controlled manner comprising:
a) STEP 1: Pull trailer from inventory.
b) STEP 2: Pick needed vending machines and secure to trailer.
c) STEP 3: Pre-load merchandise in trailers.
d) STEP 4: Check operation of trailer.
e) STEP 5: Preload change and monies into machines.
f) STEP 6: Transport to user location.
g) STEP 7: Place trailer at proper location.
h) STEP 8: Remove wheels and lower (if desired).
i) STEP 9: Connect utilities (provided at location or on trailer).
j) STEP 10: Confirm machines operates.
k) STEP 11: Confirm cage is locked and secure.
l) STEP 12: Provide service periodically as needed.
m) STEP 13: Re-install wheels.
n) STEP 14: Transport to Vending company warehouse.
o) STEP 15: Service and clean machines.
p) STEP 16: Return to inventory special machines or leave on trailer as desired.
q) STEP 17: Repeat Operation.

16. A transport and security device for one or more vending machines, comprising:
(a) a trailer with a steel alloy tubular frame and a removable and spring mounted wheel system to permit easy movement and lowering to the ground surface;
(b) an steel alloy enclosure that encircles the one or more vending machines and is comprised of a roof panel, a floor panel, side panels, and a door system with a vertical steel alloy bars and one or more locks to secure the door to the trailer and the rest of the structure of the enclosure;
(c) a means to secure and connect the vending machines to the trailer device within the enclosure whereby the vending machines may be timely and easily placed at a point of use with minimal human effort.

17. The object according to claim 16 wherein the means to secure the machines to the trailer is a universal plate secured to the trailer by a means to secure and the plate having slots and angle tabs to removably secure the vending machines in place by a fastening means.

18. The object according to claim 17 wherein the fastening means is threaded bolts and nuts which may be used with the slots of the plate to secure the machines to the plate and thus to the trailer.
